(19) United States
(12) Patent Application Publication
(10) Pub. No.: US 2020/0302188 A1
(43) Pub. Date: Sep. 24, 2020

(54) INTRA-FACILITY ACTIVITY ANALYSIS DEVICE, INTRA-FACILITY ACTIVITY ANALYSIS SYSTEM, AND INTRA-FACILITY ACTIVITY ANALYSIS METHOD

(71) Applicant: PANASONIC INTELLECTUAL PROPERTY MANAGEMENT CO., LTD., Osaka (JP)

(72) Inventor: Kazuhiko IWAI, Kanagawa (JP)

(73) Assignee: PANASONIC INTELLECTUAL PROPERTY MANAGEMENT CO., LTD., Osaka (JP)

(21) Appl. No.: 16/088,678

(22) PCT Filed: Feb. 15, 2017
(86) PCT No.: PCT/JP2017/005486

§ 371 Date: Sep. 26, 2018

(30) Foreign Application Priority Data
Apr. 8, 2016 (JP) 2016-078158

(51) Int. Cl. G06K 9/00; H04N 7/18

(52) U.S. Cl. CPC G06K 9/00778; H04N 7/181

(57) ABSTRACT

An activity information acquirer that acquires the activity information representing an activity level of the moving object for each of a plurality of predetermined detection elements acquired through division performed on the captured image, a target area setter that sets respectively target areas on at least two facility map images acquired by drawing a layout on the inside of the facility, an activity information integrator that generates the activity information for each target area by integrating activity information for each detection element in units of a target area, and an output information generator that generates display information, which is acquired by visualizing the activity information for each target area, by changing a display shape of an image representing the target area on the facility map images, for two facility map images, and generates output information which includes the display information relevant to the two facility map images.

### TECHNICAL FIELD

The present disclosure relates to an intra-facility activity analysis device, an intra-facility activity analysis system, and an intra-facility activity analysis method which perform analysis relevant to an activity state of a moving object and generates output information acquired by visualizing the activity state of the moving object on the basis of activity information generated from a captured image acquired by imaging an inside of a facility.

### BACKGROUND ART

In a store, such as a convenience store, in a case where a remedy on store management, specifically, a remedy relevant to a method for reviewing a type of merchandise and exhibiting the merchandise for each department is taken into consideration on the basis of analysis relevant to a behavior of a customer on an inside of the store, improvement of a customer satisfaction degree and effective management of the store are realized, thereby being advantageous to improve sales and profits of the store. In contrast, in the store, such as the convenience store, a monitoring system, which is installed with a camera that photographs the inside of the store and which monitors a state on the inside of the store using a captured image of the camera, is widely spread. In a case where an information processing device is caused to perform analysis relevant to the behavior of the customer on the inside of the store using the captured image of the camera, it is possible to effectively perform a work for investigating the remedies on the management of the store.

As a technology for performing analysis relevant to a behavior of a person using the captured image of the camera, a technology (refer to PTL 1) is known for acquiring an activity level of the person in each location on an inside of a monitoring area on the basis of the captured image of the camera, and generating an activity map acquired by visualizing the activity level in the related art. In the technology, the activity map is displayed by being superimposed on a disposition map of the monitoring area in a state in which division is performed on the activity map using colors in a contour shape according to the activity level of the person, and, particularly, the activity level is counted for each time zone. Therefore, the activity map is displayed for each time zone.

### CITATION LIST

### Patent Literature

PTL 1: Japanese Patent Unexamined Publication No. 2009-134688

### SUMMARY OF THE INVENTION

Meanwhile, in the technology according to the related art, it is possible to easily grasp an overall activity state of the person in the monitoring area for each time zone. However, since the activity map is displayed in a complicated shape, there is a problem in that it is not possible to immediately grasp the activity state of the person in a specific area which attracts user's attention, in the monitoring area. Particularly, although a store manager has a desire to grasp an activity trend of the customer in units of a department or in units of a floor on each story, which are classified on the basis of a type of the merchandise, a division of exhibition, or the like, it is not possible for the technology according to the related art to respond to the demand.

Here, a main object of the present disclosure is to provide an intra-facility activity analysis device, an intra-facility activity analysis system, and an intra-facility activity analysis method in which it is possible for a user to immediately grasp an activity state of a person in an area, which attracts the user's attention, on the inside of the facility.

According to an aspect of the present disclosure, there is provided an intra-facility activity analysis device, which performs analysis relevant to an activity state of a moving object on the basis of activity information generated from a captured image acquired by imaging an inside of a facility, and generates output information acquired by visualizing the activity state of the moving object, the intra-facility activity analysis device including: an activity information acquirer that acquires the activity information representing an activity level of the moving object for each of a plurality of predetermined detection elements acquired through division performed on the captured image; a target area setter that sets target areas, respectively, on at least two facility map images acquired by drawing a layout on the inside of the facility; an activity information integrator that generates the activity information for each target area by integrating activity information for each detection element; and an output information generator that generates display information, which is acquired by visualizing the activity information for each target area, by changing a display shape of an image representing the target area on the facility map images, for each facility map image, and generates the output information which includes the display information relevant to the facility map images.

In addition, according to another aspect of the present disclosure, there is provided an intra-facility activity analysis system, which performs analysis relevant to an activity state of a moving object on the basis of activity information generated from a captured image acquired by imaging an inside of a facility, and generates output information acquired by visualizing the activity state of the moving object, the intra-facility activity analysis system including: a camera that images the inside of the facility, generates the activity information representing an activity level of the moving object for each of a plurality of predetermined detection elements acquired through division performed on the captured image, and outputs the activity information; a server device that generates the output information acquired by visualizing the activity information; and a user terminal device that displays a reading screen acquired by visualizing the activity information on the basis of the output information, in which the server device includes an activity information acquirer that acquires the activity information from the camera; a target area setter that sets target areas, respectively, on at least two facility map images acquired by drawing a layout on the inside of the facility; an activity information integrator that generates the activity information for each target area by integrating activity information for each detection element in units of a target area; and an output information generator that generates display information, which is acquired by visualizing the activity information for each target area, by changing a display shape of an image representing the target area on the facility map images, for each facility map image, and generates the output information which includes the display information relevant to the facility map images.

In addition, according to further another aspect of the present disclosure, there is provided an intra-facility activity analysis method causing an information processing device to perform analysis relevant to an activity state of a moving object on the basis of activity information generated from a captured image acquired by imaging an inside of a facility and to generate output information acquired by visualizing the activity state of the moving object, the intra-facility activity analysis method including; acquiring the activity information representing an activity level of the moving object for each of a plurality of predetermined detection elements acquired through division performed on the captured image; setting target areas, respectively, on at least two facility map images acquired by drawing a layout on the inside of the facility; generating the activity information for each target area by integrating activity information for each detection element in units of a target area; and generating display information, which is acquired by visualizing the activity information for each target area, by changing a display shape of an image representing the target area on the facility map images, for each facility map image, and generating the output information which includes the display information relevant to the facility map images.

According to the present disclosure, in a case where an area, which attracts user's attention, on the inside of the facility is set as the target area, the activity information of the moving object in the target area is visualized on the facility map image. Therefore, it is possible for the user to immediately grasp the activity state of the moving object in the area, which attracts the user's attention, on the inside of the facility. Particularly, since the activity information of the moving object in the target area is visualized on a plurality of facility map images, it is possible for the user to grasp the activity state of the moving object on the inside of the facility from various points of view.

### BRIEF DESCRIPTION OF DRAWINGS

FIG. 1 is an overall configuration diagram illustrating an intra-facility activity analysis system according to an embodiment.

FIG. 2 is an elevation diagram illustrating a store and a state in the vicinity of the store.

FIG. 3 is a plan diagram illustrating a layout of a floor of the store and an installation state of camera 1.

FIG. 4 is an explanatory diagram illustrating an outline of a processing which is performed in cameras 1 and server device 2.

FIG. 5 is an explanatory diagram illustrating a district list map display screen.

FIG. 6 is an explanatory diagram illustrating a store list display screen.

FIG. 7 is an explanatory diagram illustrating a store map display screen on a whole display mode.

FIG. 8 is an explanatory diagram illustrating the store map display screen on an individual display mode.

FIG. 9 is a block diagram illustrating a hardware configuration of camera 1, server device 2, and user terminal device 3.

FIG. 10 is a functional block diagram illustrating camera 1 and server device 2.

FIG. 11 is an explanatory diagram illustrating a target area setting screen relevant to a sectional map image.

FIG. 12 is an explanatory diagram illustrating a target area setting screen relevant to a planar map image.

FIG. 13 is an explanatory diagram illustrating a camera setting screen.

FIG. 14 is an explanatory diagram illustrating an example of a result of measurement of the number of entering people, the number of leaving people, and the number of staying people which are acquired by camera 1.

FIG. 15 is an explanatory diagram illustrating another example of the store map display screen.

FIG. 16 is an explanatory diagram illustrating the store map display screen in an alarm display state.

FIG. 17A is an explanatory diagram illustrating an example of another analysis processing which is performed in controller 21 of server device 2.

FIG. 17B is an explanatory diagram illustrating an example of another analysis processing which is performed in controller 21 of server device 2.

### DESCRIPTION OF EMBODIMENTS

According to a first disclosure provided to solve the problems, there is provided an intra-facility activity analysis device, which performs analysis relevant to an activity state of a moving object on the basis of activity information generated from a captured image acquired by imaging an inside of a facility, and generates output information acquired by visualizing the activity state of the moving object, the intra-facility activity analysis device including: an activity information acquirer that acquires the activity information representing an activity level of the moving object for each of a plurality of predetermined detection elements acquired through division performed on the captured image; a target area setter that sets target areas, respectively, on at least two facility map images acquired by drawing a layout on the inside of the facility; an activity information integrator that generates the activity information for each target area by integrating activity information for each detection element; and an output information generator that generates display information, which is acquired by visualizing the activity information for each target area, by changing a display shape of an image representing the target area on the facility map images, for each facility map image, and generates the output information which includes the display information relevant to the facility map images.

Accordingly, in a case where an area, which attracts user's attention, on the inside of the facility is set on the target area, the activity information of the moving object in the target area is visualized on the facility map images, and thus it is possible for the user to immediately grasp the activity state of the moving object in the area which attracts the user's attention on the inside of the facility. Particularly, since the activity information of the moving object in the target area is visualized on the plurality of facility map images, it is possible for the user to grasp the activity state of the moving object on the inside of the facility from various points of view.

In addition, according to a second disclosure, the facility map images may include a sectional map image acquired by drawing a sectional layout of a building included in the facility, and a planar map image acquired by drawing a planar layout on a floor on the inside of the building.

Accordingly, in a case where the activity information of the moving object is visualized on the sectional map image, it is possible for the user to immediately grasp the activity state of the moving object on each story of the building included in the facility. In addition, in a case where the activity information of the moving object is visualized on the planar map image, it is possible for the user to immediately grasp the activity state of the moving object on the inside of the floor on the inside of the building.

In addition, according to a third disclosure, the output information generator may generate the display information used to display the planar map image relevant to a designated floor according to an input operation for designating the floor on the sectional map image by the user.

Accordingly, it is possible to immediately display the planar map image of the floor, which attracts attention, on the sectional map image.

In addition, according to a fourth disclosure, the intra-facility activity analysis device may further include: an alarm determinator that determines whether or not an alarm for disaster prevention is necessary for each target area on the basis of the number of current staying people, which is acquired in the activity information acquirer, for each target area, in which the output information generator generates the display information acquired by superimposing an alarm icon on a location corresponding to the target area, in which it is determined that the alarm for the disaster prevention is necessary, on the facility map image on the basis of a result of determination performed by the alarm determinator.

Accordingly, it is possible to notify the user, such as a facility manager, of a fact that the number of people who currently stay on the inside of the facility reaches a level at which there is a high possibility that the evacuation behavior is not smoothly performed if the disaster, such as the earthquake, is generated by an alarm icon, and thus it is possible to attract user's attention.

In addition, according to a fifth disclosure, the activity information integrator may integrate the activity information for each detection element in units of a facility, may generate the activity information for each facility, may average the activity information for each facility in units of a district, and may generate activity information for each district, and the output information generator may generate the display information, which is acquired by visualizing the activity information for each district, by changing a display shape of an image representing the district on a district list map image.

Accordingly, since the activity information for each district is visualized on the district list map image, it is possible for the user to immediately grasp the activity state of the moving object for each district. Particularly, the activity information for each facility is averaged in units of a district. Therefore, even in a case where the number of stores which belong to the district is different, it is possible to appropriately perform comparison on the activity state of the moving object for each district.

In addition, according to a sixth disclosure, there is provided an intra-facility activity analysis system, which performs analysis relevant to an activity state of a moving object on the basis of activity information generated from a captured image acquired by imaging an inside of a facility, and generates output information acquired by visualizing the activity state of the moving object, the intra-facility activity analysis system including: a camera that images the inside of the facility, generates the activity information representing an activity level of the moving object for each of a plurality of predetermined detection elements acquired through division performed on the captured image, and outputs the activity information; a server device that generates the output information acquired by visualizing the activity information; and a user terminal device that displays a reading screen acquired by visualizing the activity information on the basis of the output information, in which the server device includes an activity information acquirer that acquires the activity information from the camera; a target area setter that sets target areas, respectively, on at least two facility map images acquired by drawing a layout on the inside of the facility; an activity information integrator that generates the activity information for each target area by integrating activity information for each detection element in units of a target area; and an output information generator that generates display information, which is acquired by visualizing the activity information for each target area, by changing a display shape of an image representing the target area on the facility map images, for each facility map image, and generates the output information which includes the display information relevant to the facility map image.

Accordingly, similar to the first disclosure, it is possible for the user to immediately grasp the activity state of the person in an area, which attracts user's attention, on the inside of the facility.

In addition, according to a seventh disclosure, there is provided an intra-facility activity analysis method causing an information processing device to perform analysis relevant to an activity state of a moving object on the basis of activity information generated from a captured image acquired by imaging an inside of a facility and to generate output information acquired by visualizing the activity state of the moving object, the intra-facility activity analysis method including: acquiring the activity information representing an activity level of the moving object for each of a plurality of predetermined detection elements acquired through division performed on the captured image; setting target areas, respectively, on at least two facility map images acquired by drawing a layout on the inside of the facility; generating the activity information for each target area by integrating activity information for each detection element in units of a target area; and generating display information, which is acquired by visualizing the activity information for each target area, by changing a display shape of an image representing the target area on the facility map images, for each facility map image, and generating the output information which includes the display information relevant to the facility map image.

Accordingly, similar to the first disclosure, it is possible for the user to immediately grasp the activity state of the person in an area, which attracts user's attention, on the inside of the facility.

Hereinafter, an embodiment will be described with reference to the accompanying drawings.

### First Embodiment

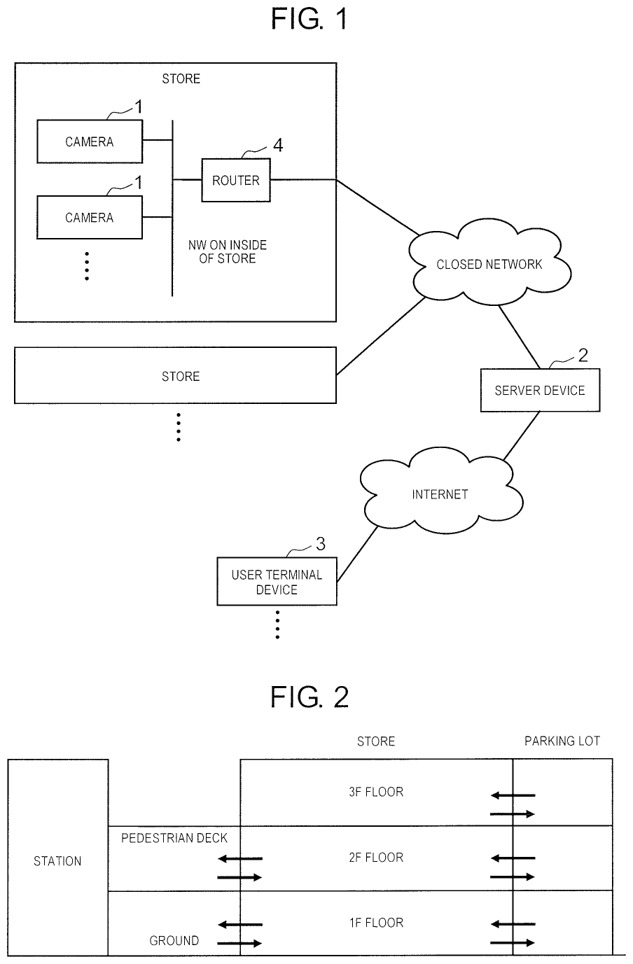

FIG. 1 is an overall configuration diagram illustrating an intra-facility activity analysis system according to the embodiment.

The intra-facility activity analysis system is constructed by targeting a retail chain store, such as a department store or a supermarket, and includes cameras 1 that are provided for each of a plurality of stores (facilities), server device (intra-facility activity analysis device) 2, and user terminal device 3.

Cameras 1 are installed in proper locations on an inside of the store, and image the inside of the store. Cameras 1 are connected to server device 2 through an in-store network or a closed network such as router 4 and a Virtual Local Area Network (VLAN). In addition, in each camera 1, an image processing for removing a person from an image acquired by imaging the inside of the store is performed, and a camera image (a processed image) acquired through the image processing is output from camera 1.

Server device 2 performs analysis relevant to an activity state of a customer on the inside of the store. Server device 2 receives the camera image or the like which is transmitted from camera 1 installed on the inside of the store. In addition, server device 2 is connected to user terminal device 3 through the Internet, generates an analysis result information reading screen and delivers the analysis result information reading screen to user terminal device 3, and acquires information which is input by the user on the reading screen.

User terminal device 3 is used for a store-side user, for example, a manger or a headquarter-side user, for example, a supervisor who provides a direction or a guidance with respect to each store in a district of responsibility to read the analysis result information, which is generated in server device 2, and includes a smart phone, a tablet terminal, or a PC. User terminal device 3 displays the analysis result information reading screen delivered from server device 2.

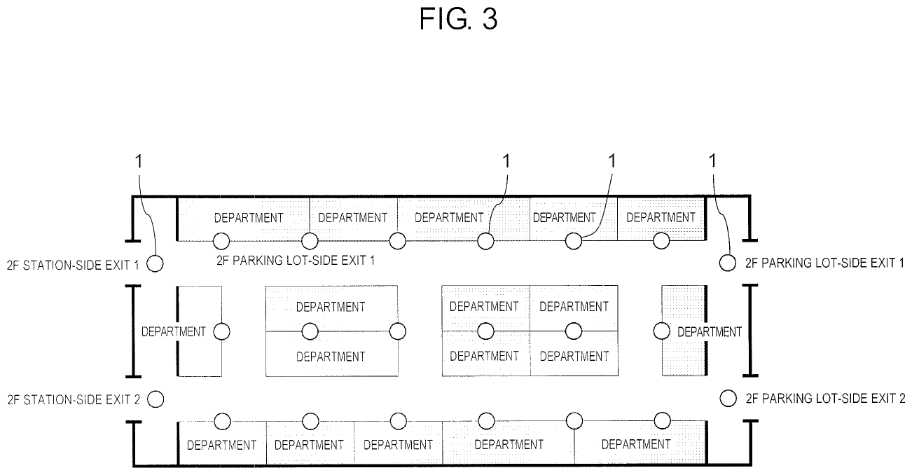

Subsequently, a layout of the store and an installation state of camera 1 will be described. FIG. 2 is an elevation diagram illustrating a store and a state in the vicinity of the store. FIG. 3 is a plan diagram illustrating a layout of a floor of the store and the installation state of camera 1.

As illustrated in FIG. 2, departments are provided on a floor of each story of the store. In addition, a parking lot is also established in the store. In an example illustrated in FIG. 2, it is possible to enter a floor of a first story from a ground on a station side. In addition, it is possible to enter a floor of a second story from the station through a pedestrian deck. In addition, it is possible to enter the floors of the first, second, and third stories, respectively, from the parking lots on the first, second, and third stories.

As illustrated in FIG. 3, the floor of the second story is provided with a station-side exit used to enter the floor of the second story from the station through the pedestrian deck, and a parking lot-side exit used to enter the floor of the second story from the second parking lot. Two station-side exits and two parking lot-side exits are provided.

In addition, departments are provided on the floor of the second story of the store, and passageways are formed between the departments. In addition, on the floor of the second story, cameras 1, which photograph the exits, and cameras 1, which photograph the departments and the passageway inside the floor, are installed. Cameras 1 are installed in appropriate locations at a ceiling on the inside of the store. In the example illustrated in FIG. 2, omnidirectional cameras, which each have a 360-degree photographing range using a fisheye lens, are applied to cameras 1. With cameras 1, it is possible to photograph customers who enter the store from the exits, customers who stay in the departments and the passageway, or the like.

Cameras 1, which photograph the exits, acquire activity information (store entering/leaving information) representing an activity level of a person (store entering/leaving state) in the exits on the basis of captured image. In the embodiment, a person who enters the store from the exit and a person who leaves the store are detected as the activity information (store entering/leaving information), and the number of people who enter the store from the exit (the number of entering people) and the number of people who leave the store (the number of leaving people) are measured on the basis of a detection result.

Cameras 1, which photograph the inside of the floor, acquire the activity information (stay information) representing the activity level of the person (stay state) in each location of the captured image on the basis of the captured image. In the embodiment, the number of people who stay on the floor (the number of staying people) and stay time, in which the person stays on the floor, are measured as the activity information (stay information).

Meanwhile, although FIG. 3 illustrates only the floor of the second story, the floor of the first story and the floor of the third story are similar to the floor of the second story other than a fact that the station-side exit does not exist on the floor of the third story.

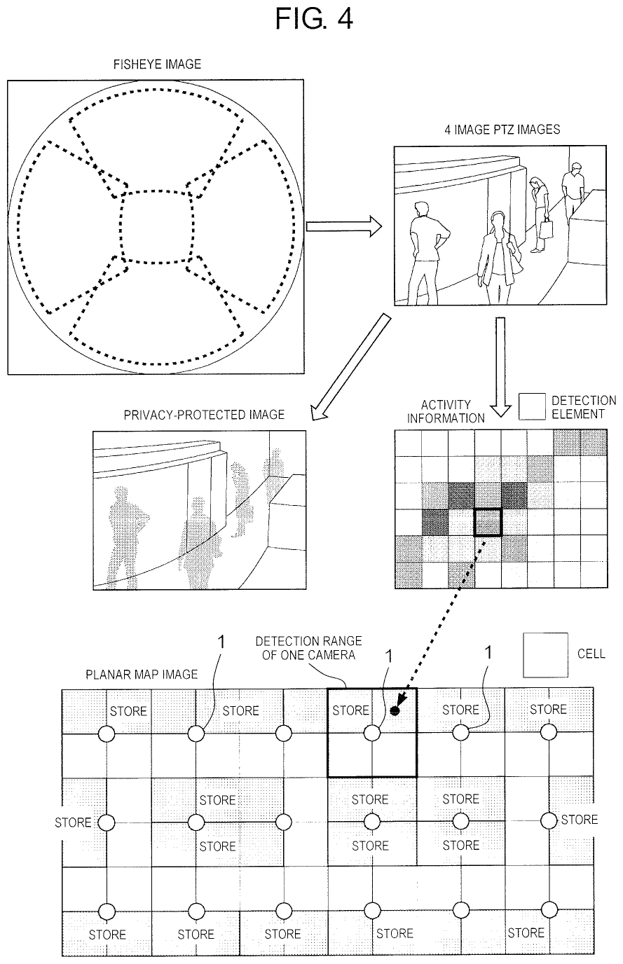

Subsequently, an outline of a processing which is performed in cameras 1 and server device 2 will be described. FIG. 4 is an explanatory diagram illustrating the outline of the processing which is performed in cameras 1 and server device 2.

Camera 1 is an omnidirectional camera, and a fisheye image is output from an image sensor by performing imaging through the fisheye lens. In camera 1, four areas are set on an image area which does not include a central part of a fisheye video, images of the four areas are cut from the fisheye image, and an image processing for performing distortion correction with respect to the images of four target areas is performed. Four corrected images (4 image PTZ images) having an aspect ratio of 4:3 are acquired as the captured image through the image processing.

In addition, in camera 1, a privacy-protected image is generated through a privacy mask processing, that is, an image processing for changing a person area in the captured image (4 image PTZ images) into a mask image. In addition, camera 1 generates the activity information representing the activity level of the person (the number of staying people and the stay time) for detection element in a lattice shape acquired through division performed on the captured image. Meanwhile, in the example illustrated in FIG. 4, the activity information for each detection element is expressed using contrasting density of a display color by targeting one image of the 4 image PTZ images.

Here, the activity information for each detection element is acquired for each predetermined unit time and the activity information for each unit time is collected during an observation period (for example, during 15 minutes or 1 hour) designated by the user. Therefore, it is possible to acquire the activity information during an arbitrary observation period corresponding to integral multiple of unit time.

Server device 2 sets cells acquired by dividing a planar map image, which is acquired by drawing a planar layout of a floor in a building of the store, into lattice shapes, and extracts the detection elements, which are located in the respective cells that are set on the planar map image, from the detection elements on the captured image. Here, mapping information relevant to a corresponding relationship between each location on the planar map image and each location on the camera image is used, and thus it is possible to map each of the detection elements on the captured image on the planar map image on the basis of the mapping information.

Meanwhile, the mapping information may be set in such a way that a photographing a range of each camera image is superimposed on the planar map image using simulation software or the like by the user. However, the mapping information may be acquired through the image processing (projective transformation or the like).

Subsequently, server device 2 generates the activity information for each cell by integrating the activity information for each extracted detection element in units of a cell. In an integrating processing, statistical processing is performed on the activity information for each detection element, and thus a representative value (an average value, a most frequent value, a medium value, or the like) representing an overall activity state of the person in the cell is acquired. In addition, in the integrating processing, the activity information is indexed by ranking (3 rankings, that is, large, small, and normal rankings, or the like) the acquired representative value using a predetermined threshold value.

In addition, in the embodiment, the target area, which includes a plurality of cells, is set. In a case where the activity information for each cell is integrated in the whole target area, activity information of the whole target area is acquired. In addition, in a case where the activity information for each cell is integrated on the whole floor, activity information of the whole floor is acquired. In addition, in a case where the activity information for each floor of each story is integrated in the whole store, activity information of the whole store is acquired.

Meanwhile, in the embodiment, the activity information for each detection element, which is acquired by dividing the captured image into the lattice shapes, is generated. However, in a case where each of the 4 image PTZ images, which are cut from the fisheye image and on which the distortion correction is performed, is generated to correspond to four cells in the vicinity of the camera, it is possible to use the activity information, which is acquired in units of 4 image PTZ images, as the activity information of each cell on the planar map image without change. In this case, each of the 4 image PTZ images becomes one detection element.

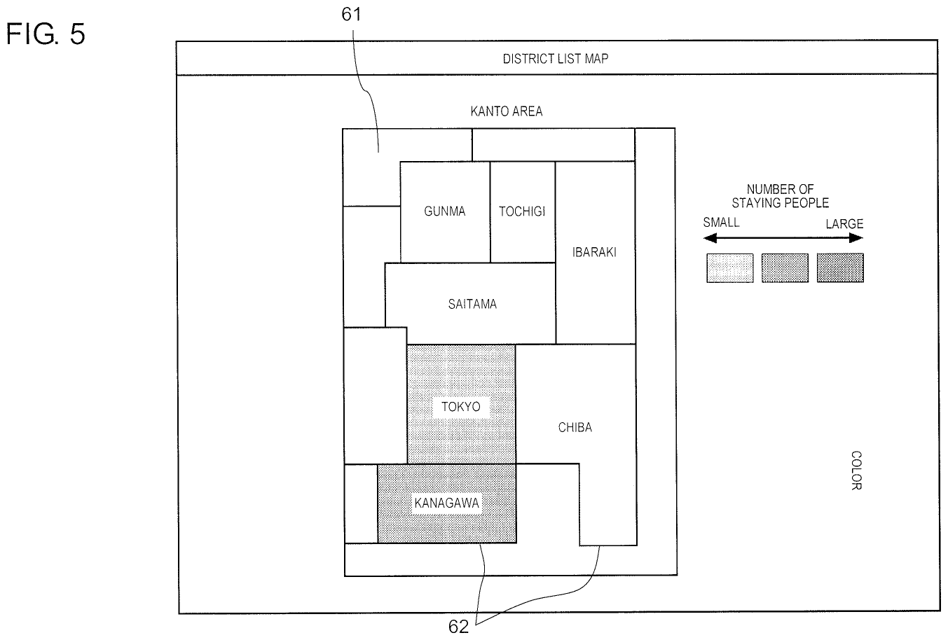

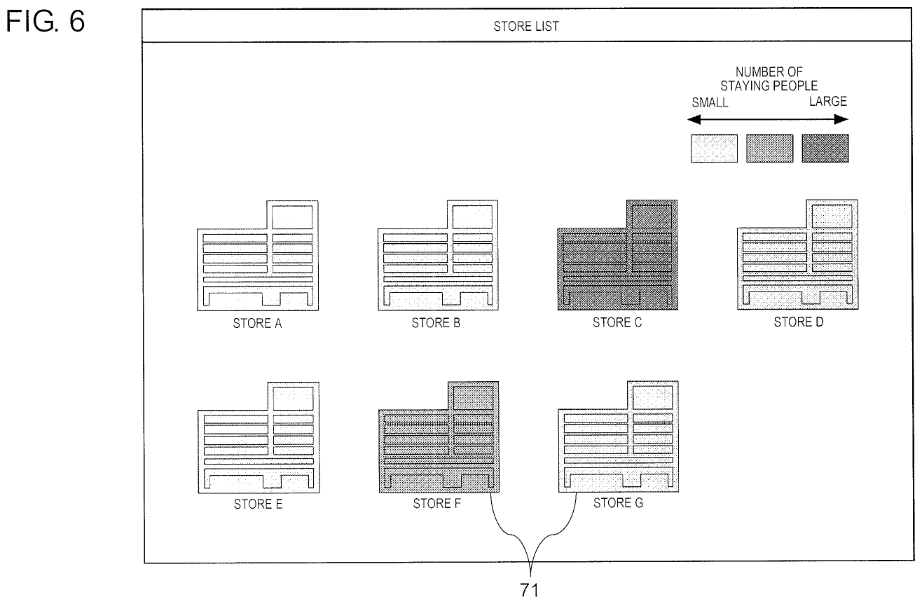

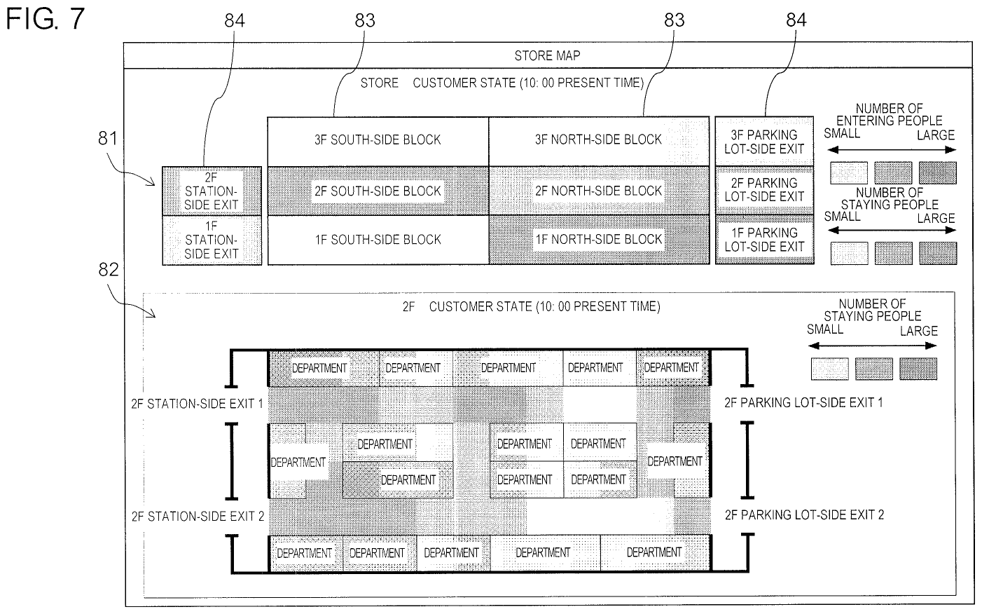

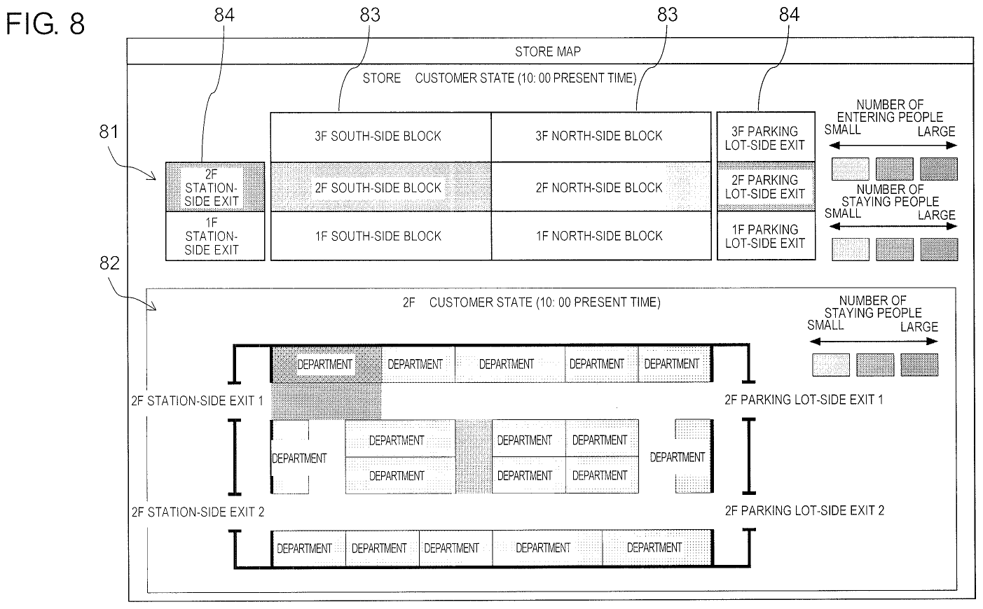

Subsequently, a screen, which is generated in server device 2 and is displayed on user terminal device 3, will be described. FIG. 5 is an explanatory diagram illustrating a district list map display screen. FIG. 6 is an explanatory diagram illustrating a store list display screen. FIG. 7 is an explanatory diagram illustrating a store map display screen on a whole display mode. FIG. 8 is an explanatory diagram illustrating the store map display screen on an individual display mode.

In the embodiment, pieces of screen information relevant to a district list map display screen (refer to FIG. 5), the store list display screen (refer to FIG. 6), and the store map display screen (refer to FIG. 7 and FIG. 8) are generated in server device 2, and the screens are displayed on user terminal device 3.

In a case where a district (here, prefecture), which attracts attention, is selected on the district list map display screen (refer to FIG. 5), transition is performed to the store list display screen (refer to FIG. 6) relevant to the selected district. Furthermore, in a case where a store, which attracts attention, is selected on the store list display screen, transition is performed to the store map display screen (refer to FIG. 7 and FIG. 8) relevant to the selected store.

As illustrated in FIG. 5, district list map image 61, which is acquired by drawing a plurality of districts (here, prefectures), is displayed on the district list map display screen. In district list map image 61, activity information (the number of staying people and the stay time) for each district is visualized by changing a display shape of area image 62 representing each district. In an example illustrated in FIG. 5, the number of staying people for each district is expressed by the display color of area image 62.

In this case, the activity information for each district is acquired on the basis of the activity information acquired from camera 1, and the display color of area image 62 is determined. In the embodiment, the activity information for each district is acquired by acquiring the activity information for each detection element on the captured image (4 image PTZ images) from each camera 1, integrating stay information for each detection element for each store, acquiring activity information for each store, and integrating the activity information for each store for each district.

Here, the number of stores which belong to the district is different. Therefore, in a case where the activity information for each store is integrated for each district, the activity information for each district is acquired by averaging the activity information for each store. In addition, the number of store visitors largely differs according to the store. Therefore, a proportion relevant to the number of staying people, for example, a congestion degree, that is, a proportion of the number of staying people with respect to the number of people to be accommodated in the store is acquired. Thereafter, the display color is determined on the basis of an average value of the congestion degree.

In a case where an operation for selecting area image 62 is performed on the district list map display screen, transition is performed to the store list display screen (refer to FIG. 6).

Meanwhile, in an example illustrated in FIG. 5, the district in the district list map display screen is set to the prefecture. However, the district may be appropriately set according to a situation of user's store management. For example, in a case of chain stores which are expanded throughout Japan, the district list map image may be acquired by drawing districts (for example, prefectures) of Japan. In addition, the district list map display screen may be displayed with two stages. For example, in a case where an area is selected on a first district list map display screen in which respective areas (for example, Kanto area, Kinki area, and the like) of Japan are drawn, transition is performed to a second district list map display screen in which districts (for example, prefectures) belonging to the selected area are drawn. In a case where a district is selected on the second district list map display screen, transition is performed to the store list map image.

Subsequently, as illustrated in FIG. 6, store icons 71 representing respective stores, which belong to the district (for example, prefecture) selected on the district list map display screen (refer to FIG. 5), are arranged and displayed on the store list display screen. In a case where a display shape of store icon 71 is changed, the activity information for each store (the number of staying people and the stay time) is visualized. In an example illustrated in FIG. 6, the activity information for each store is expressed using the display color of the store icon 71.

In this case, the activity information for each store is acquired on the basis of the activity information acquired from camera 1, and the display color of store icon 71 is determined. In the embodiment, the activity information for each detection element on the captured image (4 image PTZ images) is acquired from each camera 1, the stay information for each detection element is integrated for each store, and the activity information for each store is acquired.

In a case where an operation for selecting store icon 71 is performed on the store list display screen, transition is performed to the store map display screen (refer to FIG. 7 and FIG. 8).

Meanwhile, the store list map display screen, on which store icon 71 is disposed to correspond to an actual location of the store on an image map acquired by drawing the district (for example, prefecture), may be displayed. In addition, the activity information for each store may be displayed using a list.

Subsequently, as illustrated in FIG. 7 and FIG. 8, sectional map image (facility map image) 81 and planar map image (facility map image) 82 are displayed on the store map display screen.

Sectional map image 81 schematically expresses a story structure of the building by drawing a sectional layout of the building included in the store. In sectional map image 81, state display box 83, which displays a customer's stay state on the floor of each story, and state display box 84, which displays a customer's store entering/leaving state on the floor of each story, are arranged and provided to correspond to actual positional relation.

In examples illustrated in FIG. 7 and FIG. 8, state display box 83 is provided by dividing the floor of each story into two north and south blocks and displaying the customer's stay state in each block while using each block as the target area. In addition, state display box 84 is provided to display the customer's store entering/leaving state at the station-side exits on 1F and 2F and the parking lot-side exits of 1F to 3F. In state display boxes 83 and 84, names of the blocks and the exits are written.

In a case where an operation for selecting (clicking) state display box 83 of sectional map image 81 is performed on the store map display screen, planar map image 82 relevant to a floor corresponding to selected state display box 83 is displayed.

Meanwhile, the state display box, which displays the stay state for each floor using the whole floor as one target area, may be provided without dividing the floor of each story into the blocks.

In addition, state display box 83, which displays the customer's stay state, visualizes the customer's stay state for each block by changing the display shape. In the examples illustrated in FIG. 7 and FIG. 8, the number of staying people for each block is expressed using the display color of the state display box, and the display color of the state display box changes according to the number of staying people. Here, indexing, in which the number of staying people is ranked using a predetermined threshold value, is performed. For example, the number of staying people is ranked by three ranks, that is, less than 1000 people, equal to or larger than 1000 and less than 2000 people, and equal to or larger than 2000 people using two threshold values (1000 people and 2000 people), and the state display box is displayed with the display color according to the respective ranks.

In this case, the stay information for each block is acquired on the basis of the acquired stay information acquired from camera 1, and the display color of state display box 83 is determined. In the embodiment, the stay information for each block is acquired by acquiring the stay information for each detection element on the captured image (4 image PTZ images) from each camera 1 and integrating the stay information for each detection element for each block.

State display box 84, which displays the customer's store entering/leaving state, visualizes the customer's store entering/leaving state for each exit by changing the display shape. In the examples in FIG. 7 and FIG. 8, the number of entering people for each exit is expressed using the display color of the state display box, and the display color of the state display box changes according to the number of entering people. Here, indexing, in which the number of entering people is ranked using the predetermined threshold value, is performed. For example, the number of entering people is ranked by three ranks, that is, less than 100 people, equal to or larger than 100 and less than 200 people, and equal to or larger than 200 people using two threshold values (100 people and 200 people), and the state display box is displayed with the display color according to the respective rankings.

In this case, a display color of state display box 84 is determined on the basis of the store entering/leaving information acquired from the camera. In the embodiment, the two station-side exits and the two parking lot-side exits on the floor of each story are provided. The number of entering people for each of the station-side exits and the parking lot-side exits on each story is acquired by installing camera 1 at each exit to measure the number of entering people, and adding the number of entering people at the two exits.

In addition, in the embodiment, it is possible for the user to select any one of the whole display mode and the individual display mode. The whole display mode is used to display the stay information by targeting the whole store, and the individual display mode is used to display the stay information by targeting an area designated by the user.

As illustrated in FIG. 7, on the whole display mode, the stay information and the store entering/leaving information are displayed in all state display boxes 83 and 84. Therefore, it is possible for the user to grasp the customer's stay state and the store entering/leaving state in the whole store. In addition, as illustrated in FIG. 8, on the individual display mode, the stay information and the store entering/leaving information are displayed only in designated state display boxes 83 and 84. Therefore, it is possible for the user to grasp the customer's stay state in a block which attracts attention and the customer's store entering/leaving state in an exit which attracts attention.

Planar map image 82 is acquired by drawing a planar layout of each floor in the building. In planar map image 82, a figure representing a range of the department installed in the floor, a name of the department, a figure representing an exit, and the like are written.

In planar map image 82, the customer's stay state for each cell is visualized by changing the display shape for each cell which is set on the floor of each story. In the examples in FIG. 7 and FIG. 8, the number of staying people for each cell is expressed by the display color of each cell, and the display color of the cell changes according to the number of staying people.

In addition, similar to sectional map image 81, a display state of the stay information differs according to the display mode (the whole display mode and the individual display mode) in the planar map image 82.

That is, as illustrated in FIG. 7, on the whole display mode, the stay information is displayed in all the cells using each of all the cells, which are set on the floor, as the target area. Therefore, it is possible for the user to grasp the customer's stay state in each location of the whole floor. As illustrated in FIG. 8, on the individual display mode, the stay information is displayed using only the set target area. Therefore, it is possible for the user to grasp the customer's stay state by limiting to an area which attracts attention, for example, a specific department.

In this case, on the whole display mode, the display color for each cell is determined by acquiring the stay information for each cell on the basis of the stay information acquired from camera 1. In the embodiment, the stay information for each cell is acquired by acquiring the stay information for each detection element on the captured image (4 image PTZ images) from each camera 1 and integrating the stay information for each detection element for each cell.

In addition, on the individual display mode, the display color for each target area is determined by extracting a cell included in the target area, integrating the extracted stay information for each cell, and acquiring the stay information for each target area.

In addition, in a case where an operation for selecting (clicking) a location of an exit or an appropriate location inside the floor on planar map image 82 is performed on the store map display screen, the camera image corresponding to the selected location is displayed.

In addition, in a case where an operation for selecting (clicking) state display box 83 on sectional map image 81 is performed on the store map display screen, a diagram (a graph, a list, or the like) relevant to the customer's stay state in a block corresponding to selected state display box 83 is displayed. In addition, an operation for selecting (clicking) an appropriate location inside the floor on planar map image 82 is performed, the diagram (a graph, a list, or the like) relevant to the customer's stay state is displayed in the selected location.

In addition, in a case where an operation for selecting (clicking) state display box 84 on sectional map image 81 is performed, a diagram (a graph, a list, or the like) relevant to the customer's store entering/leaving state in the exit corresponding to selected state display box 84 is displayed. In addition, in a case where an operation for selecting (clicking) a location of an exit on planar map image 82 is performed, the diagram (a graph, a list, or the like) relevant to the customer's store entering/leaving state in the selected exit is displayed.

Meanwhile, as a diagram relevant to the customer's stay state, for example, a diagram representing a temporal transition state of the number of staying people in units of a time zone or a day is displayed. In addition, as the diagram relevant to the customer's store entering/leaving state, for example, a graph representing a temporal transition state or the like of the number of entering people or the number of leaving people in units of a time zone or a day is displayed.

Meanwhile, in the examples illustrated in FIG. 5 to FIG. 8, the map image representing the number of staying people is displayed as the activity information. However, it is possible to display the stay time, similarly.

In addition, in the examples illustrated in FIG. 5 to FIG. 8, the stay information and the store entering/leaving information are expressed according to the change in the display color. However, the stay information and the store entering/leaving information may be expressed by changing a display shape of another display element (for example, a painting pattern or the like). In addition, the number of staying people and the stay time may be simultaneously expressed using one map image by assigning different display elements to the number of staying people and the stay time which are included in the stay information. In addition, in a case where different display elements are assigned to the number of entering people and the number of leaving people which are the store entering/leaving information, the number of entering people, which is the store entering/leaving information, may be simultaneously expressed using one map image.

In addition, on the store map display screen illustrated in FIG. 7 and FIG. 8, state display box 83 relevant to the stay state and state display box 84 relevant to store entering/leaving state in sectional map image 81 display different types of information. In addition, state display box 83 relevant to the stay state in sectional map image 81 and the target area (the cell on the individual display mode) in planar map image 82 display the same type of information and different colored threshold values. Therefore, different display color systems may be used such that confusion does not occur in the information. For example, the number of staying people may be expressed using contrasting density (transmittance) of a red color in state display box 83 relevant to the stay state, the store entering/leaving information may be expressed using contrasting density (transmittance) of a green color in state display box 84 relevant to the store entering/leaving state, and the stay information may be expressed using contrasting density (transmittance) of a blue color in the target area (the cell on the individual display mode) in the planar map image. Meanwhile, it is possible to perform distinguishment using another display element such as a painting pattern (shape).

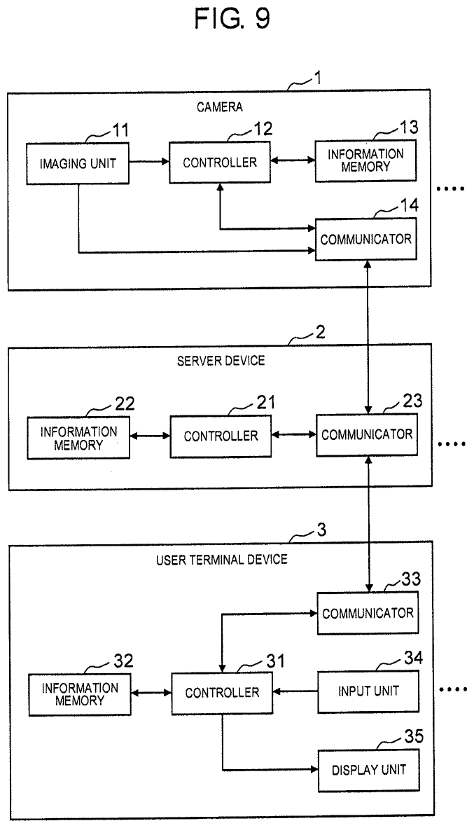

Subsequently, a schematic configuration of camera 1, server device 2, and user terminal device 3 will be described. FIG. 9 is a block diagram illustrating a hardware configuration of camera 1, server device 2, and user terminal device 3.

Camera 1 includes imaging unit 11, controller 12, information memory 13, and communicator 14.

Imaging unit 11 includes an image sensor, and sequentially outputs the captured images (frames), so-called a moving images, which are continuative in time. Controller 12 performs the image processing for changing the person area in the captured image into the mask image, and outputs the privacy-protected image, which is generated through the image processing, as the camera image. Information memory 13 stores a program, which is executed by a processor included in controller 12, and the captured image which is output from imaging unit 11. Communicator 14 performs communication between camera 1 and server device 2, and transmits the camera image, which is output from controller 12, to server device 2 through a network.

Imaging unit 11 includes the fisheye lens and an image processing circuit which performs distortion correction with respect to the fisheye video acquired by performing imaging through the fisheye lens, in addition to the image sensor. A correction image generated in the image processing circuit is output as the captured image. In the embodiment, as described above, four target areas are set on the image area which does not include the central part of the fisheye image, images of the four target areas are cut from the fisheye image, and the distortion correction is performed with respect to the images of the four target areas. Therefore, four correction videos acquired as described above, that is, the 4 image PTZ images are output.

Meanwhile, it is possible for camera 1 to output a 1 image PTZ image, a double-panorama image, and a single-panorama image in addition to the 4 image PTZ images. The 1 image PTZ image is acquired by setting one target area on the fisheye image, cutting an image of the target area from the fisheye image, and performing the distortion correction with respect to the image. The double-panorama image is acquired by cutting an image in a state in which a ring-shaped image area, other than the central part of the fisheye image, is divided into two parts, and performing the distortion correction on the image. The single panorama image is acquired by cutting a video, other than arch-shaped image areas which are in symmetry locations with respect to the central part of the fisheye video, from the fisheye image, and performing the distortion correction with respect to the image.

Server device 2 includes controller 21, information memory 22, and communicator 23.

Communicator 23 performs communication between camera 1 and user terminal device 3, receives the camera image, which is transmitted from camera 1, receives user setting information, which is transmitted from user terminal device 3, and delivers the analysis result information reading screen to user terminal device 3. Information memory 22 stores the camera image, which is received by communicator 23, a program, which is executed by a processor included in controller 21, and the like. Controller 21 performs analysis relevant to an activity state of a customer on the inside of the store, and generates the analysis result information reading screen to be delivered to user terminal device 3.

User terminal device 3 includes controller 31, information memory 32, communicator 33, input unit 34, and display unit 35.

Input unit 34 is used for the user to input various pieces of setting information. Display unit 35 displays the analysis result information reading screen on the basis of the screen information which is transmitted from server device 2. It is possible to form input unit 34 and display unit 35 using a touch panel display. Communicator 33 performs communication between user terminal device 3 and server device 2, transmits the user setting information, which is input by input unit 34, to server device 2, and receives the screen information which is transmitted from server device 2. Controller 31 controls each of the units of user terminal device 3. Information memory 32 stores a program which is executed by the processor included in the controller 31.

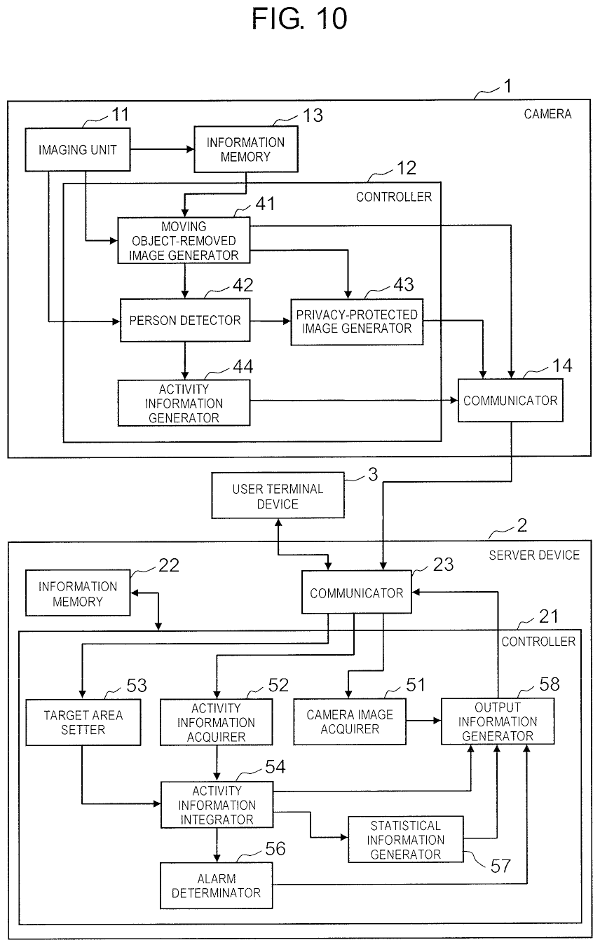

Subsequently, a functional configuration of camera 1 and server device 2 will be described. FIG. 10 is a functional block diagram illustrating camera 1 and server device 2.

Controller 12 of camera 1 includes moving object-removed image generator 41, person detector 42, privacy-protected image generator 43, and activity information generator 44. Each of the units of controller 12 is realized by causing the processor included in controller 12 to execute an intra-facility activity analysis program (instruction) which is stored in information memory 13.

On the basis of a plurality of captured images (frames) during a predetermined learning period, moving object-removed image generator 41 generates the moving object-removed image (refer to FIG. 4) acquired by removing the moving object such as person from the captured image. Specifically, in a case where the captured images, which are output from imaging unit 11 and which are continuative in time, are sequentially input to moving object-removed image generator 41, moving object-removed image generator 41 generates the moving object-removed image (background image) by acquiring governing image information (color information in a prevailing condition) in units of a pixel on the basis of the plurality of captured images during an immediately before predetermined sampling period. Furthermore, in a case where the governing image information is updated whenever the captured images are input, it is possible to acquire a newest moving object-removed image. A well-known background image generation technology may be used to generate the moving object-removed image.

Person detector 42 compares the moving object-removed image (background image) acquired in moving object-removed image generator 41 with a current captured image output from imaging unit 11, and specifies the image area of the moving object in the captured image based on difference between the moving object-removed image and the current captured image (moving object detection). Furthermore, in a case where a Ω shape, which includes a face, a head, and a shoulder of a person, is detected in the image area of the moving object, the moving object is determined to be the person (person detection). A well-known technology may be used to detect the moving object and the person.

In addition, person detector 42 acquires a moving line for each person on the basis of a result of detection of the person. In this processing, the moving line may be generated in such a way as to acquire coordinates of a central point of the person and to connect the central point. Meanwhile, information acquired in person detector 42 includes time information relevant to detection time for each person, which is acquired based on time in which the captured image, in which the person is detected, is photographed.

Privacy-protected image generator 43 generates the privacy-protected image (refer to FIG. 4) acquired by changing the area of the person in the captured image, which is output from the imaging unit 11, into the mask image on the basis of the result of the detection performed by person detector 42.

In a case where the privacy-protected image is generated, first, the mask image, which has contours corresponding to the image person area is generated, based on the positional information of the person in the image area acquired in person detector 42. Furthermore, the privacy-protected image is generated by superimposing the mask image on the moving object-removed image acquired in moving object-removed image generator 41. The mask image is acquired by filling the insides of the contours of the person with a predetermined color (for example, a blue color), and has permeability. In the privacy-protected image, a state in which background image is viewed through a part of the mask image is acquired.

Activity information generator 44 acquires the activity information representing the activity level of the person during the predetermined observation period for each detection element in the lattice shape, which is acquired through division performed on the captured image (4 image PTZ images) on the basis of a result of detection in person detector 42. In the embodiment, the number of staying people and the stay time is acquired as the activity information representing the activity level of the person in the floor of the store on the basis of moving line information, which is acquired in person detector 42, for each person.

In a case where the number of staying people is acquired, the number of moving lines of each person who passes through each detection element is counted, and thus the number of staying people of each detection element is acquired. In a case where the stay time is acquired, first, sojourn time (entry time and exit time with respect to the detection element) for each person is acquired by targeting the moving line of each person who passes through each detection element, subsequently, the stay time for each person is acquired based on the sojourn time for each person, subsequently, an averaging processing (statistical processing) is performed with respect to the stay time for each person, and thus the stay time for each detection element is acquired.

In addition, activity information generator 44 detects a person who enters the store from the exit of the store and a person who leaves the store on the basis of the result of detection performed in person detector 42, and measures the number of entering people (the number of people who enter the store from the exit) and the number of leaving people (the number of people who leave the store from the exit) during the predetermined observation period on the basis of the result of the detection. Specifically, a count line is set on the captured image (4 image PTZ images) and the number of people who pass the count line is measured. In addition, in a case where a movement direction of the person is detected, it is possible to determine the person who enters the store and the person who leaves the store.

Meanwhile, the measurement of the number of staying people and the stay time is performed by camera 1 which is installed on the floor, and measurement of the number of entering people and the number of leaving people is performed by camera 1 which is installed at the exit.

Meanwhile, after acquiring the activity information for each detection element for each unit time, activity information generator 44 may acquire the activity information for each detection element during the observation period by integrating the activity information for each unit time during a predetermined observation period (for example, 1 hour) through the statics processing (adding, averaging, or the like). In addition, in a case where the activity information for each detection element during the observation period is generated for each person, it is possible to prevent the server device 2 from overlapping the person in a case where the activity information is indexed (integrated) in the whole target area.

The privacy-protected image, which is acquired by privacy-protected image generator 43, is transmitted as the camera image from communicator 14 to server device 2 at a predetermined unit time interval (for example, at 15-minute interval). Specifically, server device 2 periodically performs an image transmission demand with respect to camera 1 in predetermined timing (for example, at 15-minute interval), and communicator 14 of camera 1 transmits the camera image at that time according to the image transmission demand from server device 2.

In addition, the activity information, which is acquired by activity information generator 44, is also transmitted from communicator 14 to server device 2. The activity information may be transmitted to server device 2 at the same timing as the camera image. However, the activity information may be transmitted to server device 2 at different timing from the camera image.

Meanwhile, in a case where the activity information is transmitted at the same timing as the camera image, the observation period of the activity information may coincide with the transmission interval (for example, at 15-minute interval). Here, in a case where it is desired to acquire the activity information during the observation period which is longer than the transmission interval, the activity information acquired from camera 1 may be aggregated in server device. For example, in a case where the transmission interval is the 15-minute interval and the activity information for 15 minutes is added until it's been 1 hour, it is possible to acquire the activity information corresponding to 1 hour.

In addition, the moving object-removed image, which is generated by moving object-removed image generator 41, may be transmitted to server device 2 as the camera image. In addition, the moving object-removed image and the mask image information (the mask image or the positional information of the person in the image area) may be transmitted from camera 1 to server device 2, and the privacy-protected image may be generated in server device 2.

Controller 21 of server device 2 includes camera image acquirer 51, activity information acquirer 52, target area setter 53, activity information integrator 54, alarm determinator 56, statistical information generator 57, and output information generator 58. Each of the units of controller 21 is realized by causing the processor included in controller 21 to execute an intra-facility activity analysis program (instruction) stored in information memory 22.

Camera image acquirer 51 acquires the camera image which is periodically (for example, 15-minute interval) transmitted from camera 1 and is received by communicator 23. The camera image, which is acquired by camera image acquirer 51, is stored in information memory 22.

Activity information acquirer 52 acquires the activity information which is transmitted from camera 1 and is received by communicator 23. The activity information, which is acquired by activity information acquirer 52, is stored in information memory 22.

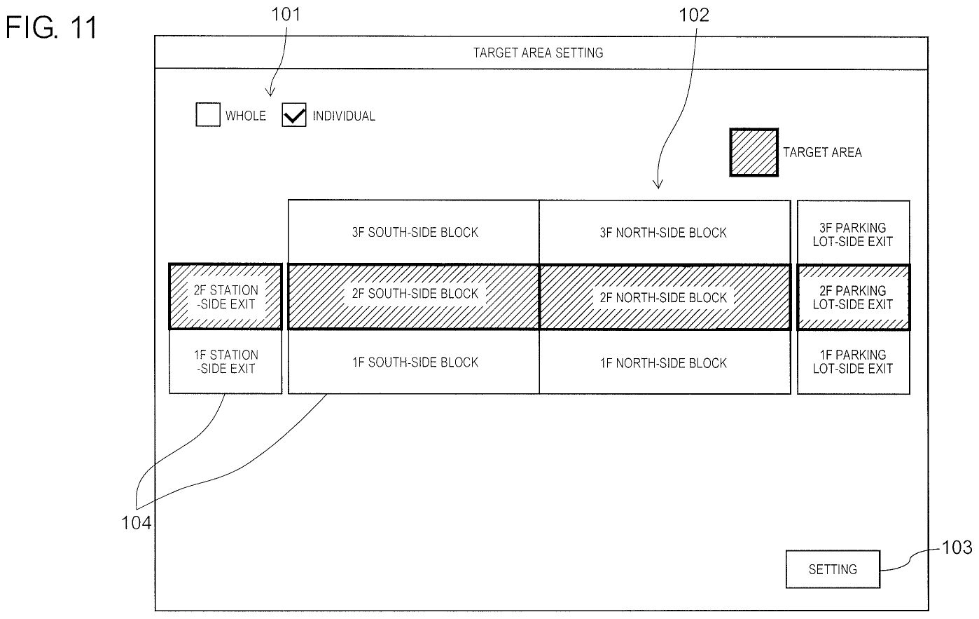

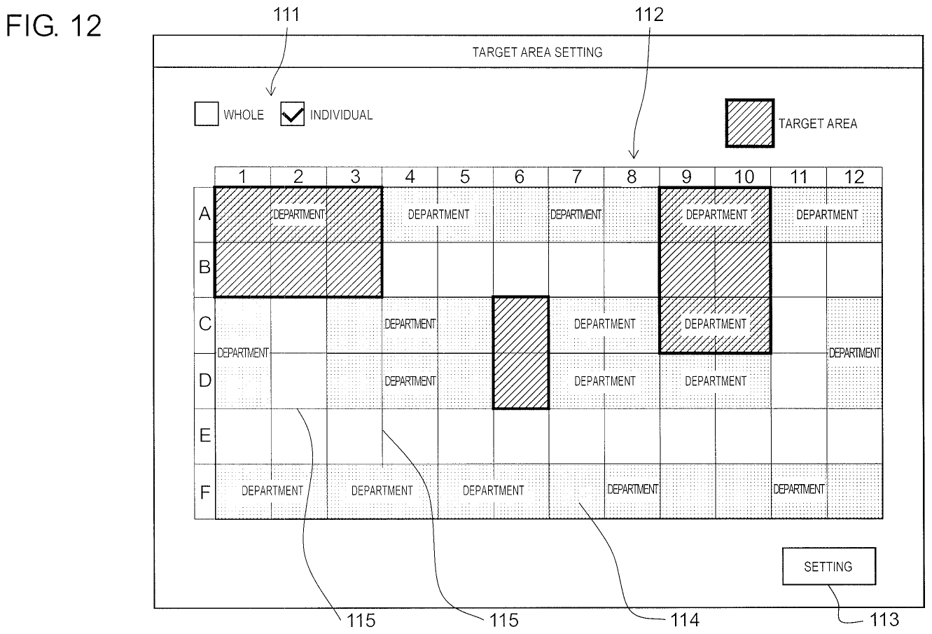

Target area setter 53 sets the target area on each of the sectional map image and the planar map image according to an input operation performed by the user in user terminal device 3. Specifically, in a case where a right click operation or the like is performed on a store map screen (refer to FIG. 7 and FIG. 8), a target area setting screen (FIG. 11 and FIG. 12), on which the sectional map image and the planar map image are displayed respectively, is displayed on user terminal device 3, and thus the user is caused to designate the target area on the target area setting screen.

Activity information integrator 54 performs a processing for integrating the activity information, which is acquired by activity information acquirer 52, for each target area which is set in target area setter 53. In the embodiment, the activity information for each detection element in the camera image is acquired from camera 1. In addition, information memory 22 stores the mapping information relevant to a corresponding relationship between each location on the camera image and each location on the store map image (the sectional map image and the planar map image). Activity information integrator 54 generates the activity information for each target area by extracting the detection element, which is located in the target area, from the detection elements of the camera image on the basis of the mapping information and integrating (statistical processing) the activity information of each extracted detection element. Here, the average value and the most frequent value of the activity information of each cell may be acquired.

In the embodiment, two blocks, which are acquired by dividing the floor of each story of the store into north and south directions, are set as the target areas, and the stay information (the number of staying people and the stay time) for each block is generated. In addition, the stay information for each target area, which is set on the floor of each story by the user, is generated. In addition, the stay information for each cell is generated using each cell, which is set on the floor of each story, as the target area.

In addition, activity information integrator 54 acquires the number of entering people and the number of leaving people on each story by integrating the number of entering people and the number of leaving people for each exit on the floor of each story of the store.

In addition, activity information integrator 54 generates the activity information for each store by integrating the activity information for each detection element in units of a store, and generates the activity information for each district by averaging the activity information for each store in units of a district.

Alarm determinator 56 determines whether or not an alarm for disaster prevention is necessary for each target area, that is, whether or not the number of current staying people reaches a level at which there is a high possibility of being a dangerous state if a disaster is generated, on the basis of the number of current staying people for each target area acquired in activity information integrator 54.

Statistical information generator 57 generates statistical information used to generate the diagram relevant to the customer's stay state (a graph, a list, or the like). Specifically, statistical information generator 57 generates statistical information used to generate a graph relevant to the number of staying people by targeting the whole store, the floor of each story, the blocks acquired by dividing the floor, the cells which are set to the floor, and the target area including the plurality of cells, for example, a graph representing the temporal transition state of the number of staying people in units of a time zone or a day. In addition, statistical information generator 57 generates statistical information used to generate a graph relevant to the number of entering people and the number of leaving people by targeting the exit of each story, for example, a graph representing the temporal transition state of the number of entering people or the number of leaving people in units of a time zone or a day.

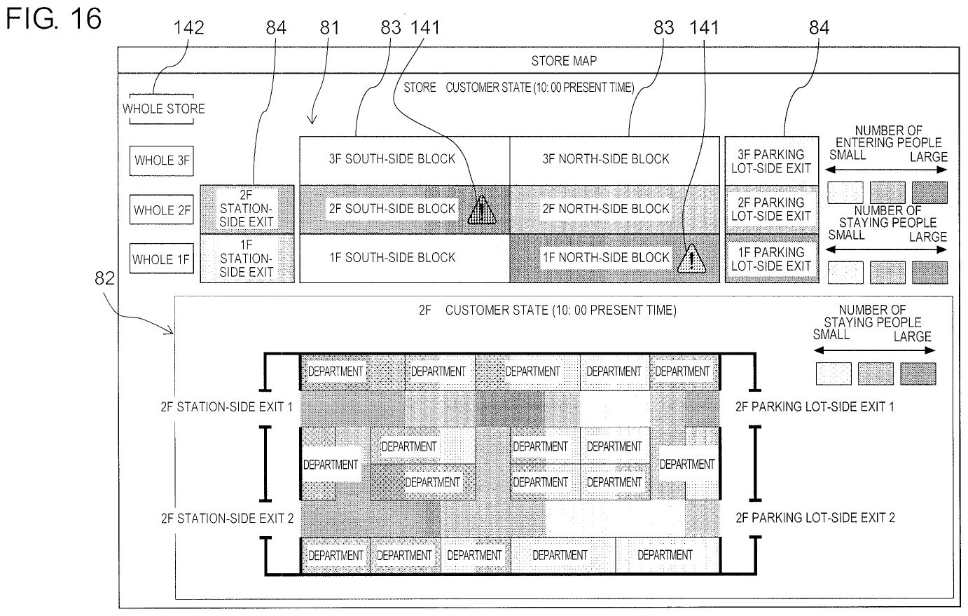

Output information generator 58 generates display information relevant to the district list map display screen (refer to FIG. 5), the store list display screen (refer to FIG. 6), the store map display screen (refer to FIG. 7 and FIG. 8), the target area setting screen (FIG. 11 and FIG. 12), and the store map display screen in an alarm display state (FIG. 16).

Particularly, output information generator 58 generates the display information used to visualize the activity information for each target area for each of the sectional map image and the planar map image by changing the display shape of an image representing the target area on the sectional map image and the planar map image on the basis of the activity information for each target area acquired in activity information integrator 54, and generates output information which includes the display information relevant to the sectional map image and the planar map image.

In addition, output information generator 58 generates the display information used to display the planar map image of a designated floor according to an input operation of the user for designating the floor on the sectional map image.

In addition, output information generator 58 generates the display information used to visualize the activity information for each district by changing the display shape of area image 62 (refer to FIG. 5) representing the district on the district list map image on the basis of the activity information for each district acquired in activity information integrator 54.

In addition, output information generator 58 generates the display information used to visualize the activity information for each store by changing the display shape of store icon 71 (refer to FIG. 6) on the basis of the activity information, which is acquired in activity information integrator 54, for each store.

In addition, output information generator 58 generates the display information, in which an alarm notification image used to notify the user of an alert of an alarm is superimposed on a location corresponding to the target area where it is determined that the alarm for disaster prevention is necessary in the sectional map image, on the basis of a result of determination performed in alarm determinator 56. In the embodiment, as the alarm notification image, alarm icon 141 and alarm display box 142 (refer to FIG. 16) are displayed by being superimposed on the sectional map image.

Subsequently, the target area setting screen, which is generated in server device 2 and is displayed on user terminal device 3, will be described. FIG. 11 is an explanatory diagram illustrating the target area setting screen relevant to the sectional map image. FIG. 12 is an explanatory diagram illustrating the target area setting screen relevant to the planar map image.

In the embodiment, it is possible for the user to select any one of the whole display mode (refer to FIG. 7), which displays the stay information by targeting the whole store on the store map display screen, and the individual display mode (refer to FIG. 8) which displays the activity information by limiting an area that attracts the user's attention on the store map display screen. The display mode is selected on the target area setting screen illustrated in FIG. 11 and FIG. 12.

In addition, on the target area setting screen illustrated in FIG. 11 and FIG. 12, it is possible for the user to designate the target area, which displays the stay information and the store entering/leaving information, on the individual display mode.

As illustrated in FIG. 11, the target area setting screen relevant to the sectional map image is provided with display mode selector 101, target area designator 102, and setting button 103.

Display mode selector 101 is provided with “whole” and “individual” check boxes, and it is possible to select any one of “whole” and “individual”. In a case where “whole” is selected, the mode becomes the whole display mode. In a case where “individual” is selected, the mode becomes the individual display mode.

Here, in a case where the display mode is selected and a pointer is matched with display mode selector 101 by operating input unit 34 (a pointing device such as a mouse), an explanatory note is pop-up displayed. In a case where the pointer is matched with a “whole” display area, a message, which explains the whole display mode, for example, a statement “Heat map information for each cell is displayed by targeting the whole floor!” is displayed. In addition, in a case where the pointer is matched with an “individual” display area, a message, which explains the individual display mode, for example, a statement “Heat map information for each selected range is displayed! It is possible to designate a plurality of ranges!” is displayed.

In a case where setting button 103 is operated by selecting “whole” in display mode selector 101, the whole blocks and exits are set to the target area.

In contrast, in a case where “individual” is selected in display mode selector 101, it is possible to designate state display boxes 83 and 84 (refer to FIG. 7 and FIG. 8) which are display targets in target area designator 102.

Target area designator 102 is provided with selection boxes 104 corresponding to the respective state display boxes 83 and 84. In selection box 104, names of the blocks and the exits are written. The user sequentially selects selection boxes 104. In a case where setting button 103 is operated, state display boxes 83 and 84 which become the display target are set.

As illustrated in FIG. 12, display mode selector 111, target area designator 112, and setting button 113 are provided on the target area setting screen relevant to the planar map image.

Display mode selector 111 is similar to display mode selector 101 on the target area setting screen relevant to the sectional map image illustrated in FIG. 11.

In a case where “whole” is selected in display mode selector 111 and setting button 113 is operated, each of the whole cells is set to the target area.

In contrast, in a case where “individual” is selected in display mode selector 111, it is possible to designate the cells included in the target area in target area designator 112. That is, it is possible to designate a rage of the target area in units of a cell.

In target area designator 112, boundary lines 115 of the cells are displayed by being superimposed on map image 114 acquired by drawing the layout of the floor. In map image 114, names of the departments or the like installed on the floor are previously written. The user sequentially selects the cells included in the target area while viewing map image 114. In a case where setting button 113 is operated, a range of the target area is set.

In addition, it is possible to designate a plurality of target areas. In this case, a work of operating setting button 113 by selecting the cells included in the range of the target area may be repeated.

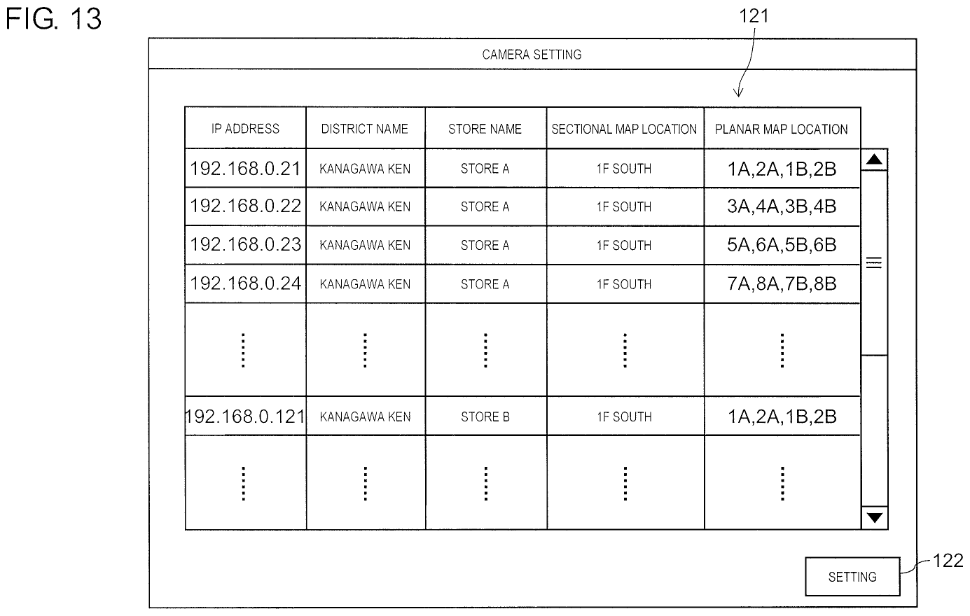

Subsequently, a camera setting screen, which is generated in server device 2 and is displayed on user terminal device 3, will be described. FIG. 13 is an explanatory diagram illustrating the camera setting screen.

The camera setting screen is used for the user to input camera setting information relevant to camera 1, which becomes a system target, and is provided with camera setting information input unit 121 and setting button 122.

The camera setting information is used to associate information, which is displayed on the district list map display screen (refer to FIG. 5), the store list display screen (refer to FIG. 6), and the store map display screen (refer to FIG. 7 and FIG. 8), with camera 1. The camera setting information includes respective items such as a district name (prefecture name), a store name, a sectional map location, and a planar map location.

In an item corresponding to the district name (prefecture name) of camera setting information input unit 121, a name of the district where the store, in which the camera 1 is installed, exists is input. In an item corresponding to the store name, a name of the store in which the camera 1 is installed is input. In an item corresponding to the sectional map location, a name of a location (block or the like) on the inside of the store in which camera 1 is installed is input. In an item corresponding to the planar map location, a cell number (a number given to each cell on the planar map image), which is a detection target of camera 1, is input.

In a case where setting button 122 is operated by inputting each of the items of camera setting information input unit 121, the camera setting information is confirmed using input content, and the camera setting information is stored in information memory 22 of server device 2. Meanwhile, in the above, an example in which the camera setting information is input from user terminal device 3 is described. However, the camera setting information may be previously stored on the inside of camera 1, and the camera setting information may be uploaded on information memory 22 of server device 2 in a case where camera 1 is installed.

The camera setting information is referred to in a case where respective pieces of screen information of the district list map display screen (refer to FIG. 5), the store list display screen (refer to FIG. 6), and the store map display screen (refer to FIG. 7 and FIG. 8) are generated.

That is, in a case where the screen information of the district list map display screen (refer to FIG. 5) is generated, camera 1 installed in each store in a relevant district (prefecture) is extracted on the basis of the camera setting information, and the activity information acquired in each extracted camera 1 is integrated. Thereafter, the activity information for each district is acquired, and the activity information for each district is displayed on the district list map display screen.

In addition, in a case where the screen information of the store list display screen (refer to FIG. 6) is generated, camera 1 installed in the relevant store is extracted on the basis of the camera setting information, and the activity information acquired in each extracted camera 1 is integrated. Thereafter, the activity information for each store is acquired, and the activity information for each store is displayed on the store list display screen.

In addition, in a case where the screen information of the store map display screen (refer to FIG. 7 and FIG. 8) is generated, camera 1 related to the relevant target area is extracted on the basis of the camera setting information, and the activity information acquired in each extracted camera 1 is integrated. Thereafter, the activity information for each target area is acquired, and the activity information for each target area is displayed on the store map display screen.

Here, camera 1 related to the target area in sectional map image 81 of the store map display screen is extracted on the basis of “sectional map location” information of the camera setting information, and camera 1 related to the target area in planar map image 82 is extracted on the basis of “planar map location” information of the camera setting information. In addition, on the whole display mode, cameras 1 related to the whole blocks and the exits in the sectional map image are extracted. In addition, cameras 1 related to the whole cells in the planar map image are extracted. In contrast, on the individual display mode, cameras 1 related to the blocks and the exits included in the target area in the sectional map image are extracted. In addition, cameras 1 related to the cells included in the target area in the planar map image are extracted.

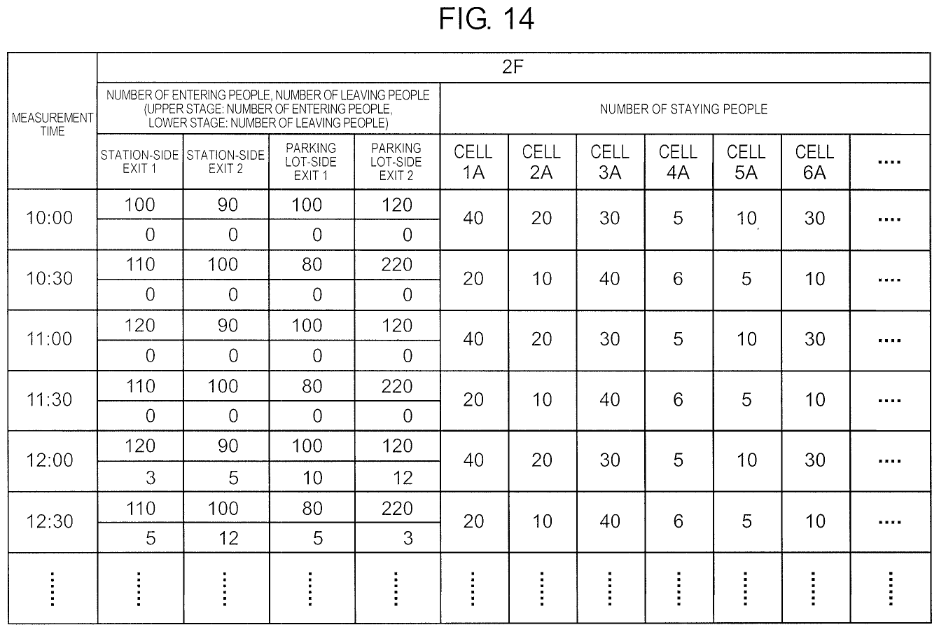

Subsequently, a result of the measurement of the number of entering people, the number of leaving people, and the number of staying people, which are acquired by camera 1, will be described. FIG. 14 an explanatory diagram illustrating an example of the result of the measurement of the number of entering people, the number of leaving people, and the number of staying people which are acquired by camera 1.

The number of entering people and the number of leaving people at each of station-side exit 1, station-side exit 2, parking lot-side exit 1, and parking lot-side exit 2 are measured by each camera 1 which images each exit of the station-side exit and the parking lot-side exit. Furthermore, in a case where the number of entering people and the number of leaving people at station-side exit 1 are added to the number of entering people and the number of leaving people at station-side exit 2, it is possible to acquire the number of entering people and the number of leaving people at a station-side exit which is visualized on sectional map image 81 (refer to FIG. 7 and FIG. 8). In addition, in a case where the number of entering people and the number of leaving people at parking lot-side exit 1 are added to the number of entering people and the number of leaving people at parking lot-side exit 2, it is possible to acquire the number of entering people and the number of leaving people at a 2F parking lot-side exit which is visualized on sectional map image 81.

In addition, the number of staying people for each cell is measured by each camera 1 which images the department on the inside of the floor. Furthermore, the number of staying people for each cell is visualized on planar map image 82 on the whole display mode without change. In addition, in a case where the number of staying people for each cell, included in the target area, is added, it is possible to acquire the number of staying people in the target area which is visualized on planar map image 82 on individual display mode.

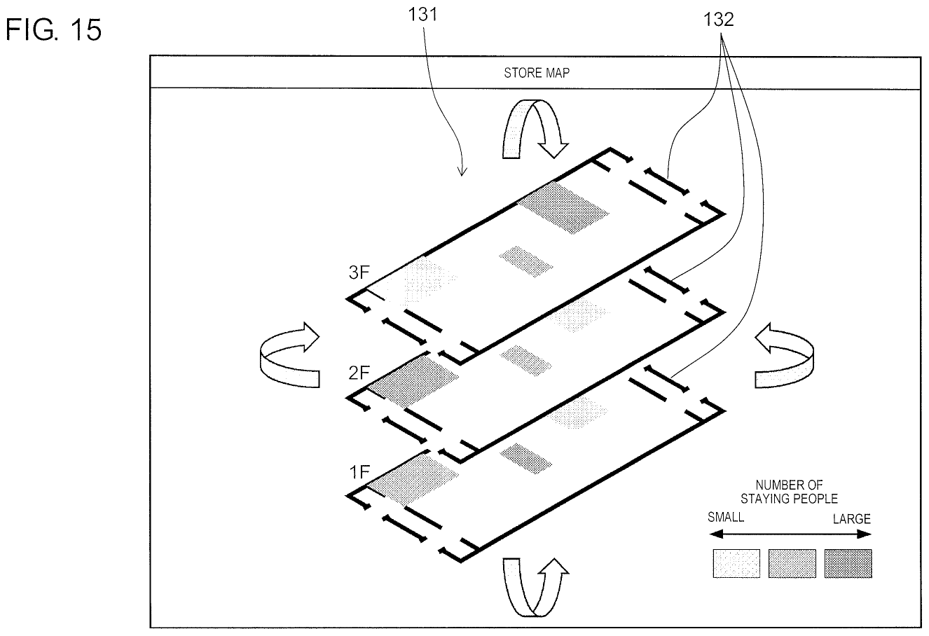

Subsequently, another example of the store map display screen, which is generated in server device 2 and is displayed on user terminal device 3, will be described. FIG. 15 is an explanatory diagram illustrating another example of the store map display screen.

On the store map display screen, store map image 131 is displayed in three dimensions. Specifically, perspective map image 132, in which planar map image 82 that displays a state of the floor of each story is expressed using a perspective diagram, is vertically disposed. In addition, store map image 131 is displayed on the basis of 3D image data, and has a function, so-called a 3D view function, in which it is possible to rotate store map image 131 using a drag operation or the like.

Subsequently, the store map display screen in the alarm display state will be described. FIG. 16 is an explanatory diagram illustrating the store map display screen in the alarm display state.

In the embodiment, alarm determinator 56 of server device 2 determines whether or not the alarm for disaster prevention is necessary, that is, whether or not the number of current staying people reaches a level at which there is a high possibility that an evacuation behavior is not smoothly performed if a disaster, such as an earthquake, is generated on the basis of the number of current staying people acquired in activity information acquirer 52.

Furthermore, in a case where it is determined that the alarm for the disaster prevention is necessary in alarm determinator 56, a processing for displaying alarm icon 141 on the store map display screen is performed in output information generator 58, as illustrated in FIG. 16. In an example illustrated in FIG. 16, determination of whether or not the alarm for the disaster prevention is necessary is performed by targeting south and north blocks of each floor, and alarm icon 141 is displayed in relevant state display box 83 on sectional map image 81.

In alarm determination, in a case where the number of current staying people is compared with the predetermined threshold value and the number of current staying people is larger than the threshold value, alarm icon 141 is displayed. In the example illustrated in FIG. 16, an alarm level is evaluated in three stages, that is, normal, caution, and warning using two thresholds, that is, first and second threshold values, and the display colors of alarm icon 141 change according to the alarm level.

That is, in a case where the number of staying people is not larger than the first threshold value, the alarm level is set to OK and alarm icon 141 is not displayed. In a case where the number of staying people is larger than the first threshold value and is not larger than the second threshold value, the alarm level is set to the caution and caution alarm icon 141 is displayed using, for example, a yellow color. In a case where the number of staying people is larger than the second threshold value, the alarm level is set to the warning and warning alarm icon 141 is displayed using, for example, a red color.

In addition, alarm display box 142, which targets the whole store and the whole floor of each story, is provided on the screen. In alarm display box 142, the display color changes in a case where the alarm for the disaster prevention is necessary. For example, in a case where the alarm level is normal, alarm display box 142 is displayed using a white color. In a case where the alarm level is the caution, alarm display box 142 is displayed using a yellow color. In a case where the alarm level is warning, alarm display box 142 is using a red color.

Meanwhile, the threshold value used for the alarm determination is set on the basis of the proper number of people in the target area. That is, in the alarm determination for each floor, the determination is performed using the threshold value on the basis of the proper number of people on the floor. For example, in a case where the proper number of people on the floor is 2000 people, 3000 people corresponding to 150% of 2000 people is used as the threshold value. Therefore, in a case where the number of staying people on the whole floor is larger than 3000 people, the alarm is displayed. In addition, in the alarm determination of the whole store, determination is performed using the threshold value on the basis of the proper number of people in the whole store. For example, in a case where the proper number of people in the whole store is 6000 people, 9000 people corresponding to 150% of 6000 people is used as the threshold value. Therefore, in a case where the number of staying people in the whole store is larger than 9000 people, the alarm is displayed.

With the store map display screen in the alarm display state as described above, it is possible to notify a store manager, such as a guard, or the user, such as a department manager of a fact that the number of customers who currently stay on the inside of the store reaches the level at which there is a high possibility that the evacuation behavior is not smoothly performed if the disaster, such as the earthquake, is generated, and thus it is possible to attract user's attention.

Meanwhile, the threshold value used for the alarm determination may be different from the threshold value used in a case where state display box and the display color of the cell are determined on the basis of the activity information.

Meanwhile, the alarm may be displayed on the district list map display screen (refer to FIG. 5) and the store list display screen (refer to FIG. 6). In this case, on the district list map display screen, the alarm icon may be displayed on area image 62 representing a district by targeting the district where a store, which is determined that the alarm for the disaster prevention is necessary, exists in any of the areas on the inside of the store. In addition, on the store list display screen, the alarm icon may be displayed on store icon 71 and in the vicinity of store icon 71 by targeting a store, which is determined that the alarm for the disaster prevention is necessary in any of the blocks on the inside of the store.

In addition, a message, which notifies the user of an area of a store where the alarm is alerted, may be displayed on the district list map display screen and the store list display screen. In addition, the alarm is displayed in units of a district (prefecture) on the district list map display screen. However, in a case where a district where the alarm is displayed is selected on the district map display screen, transition may be performed to the store map display screen corresponding to the store where the alarm is alerted.

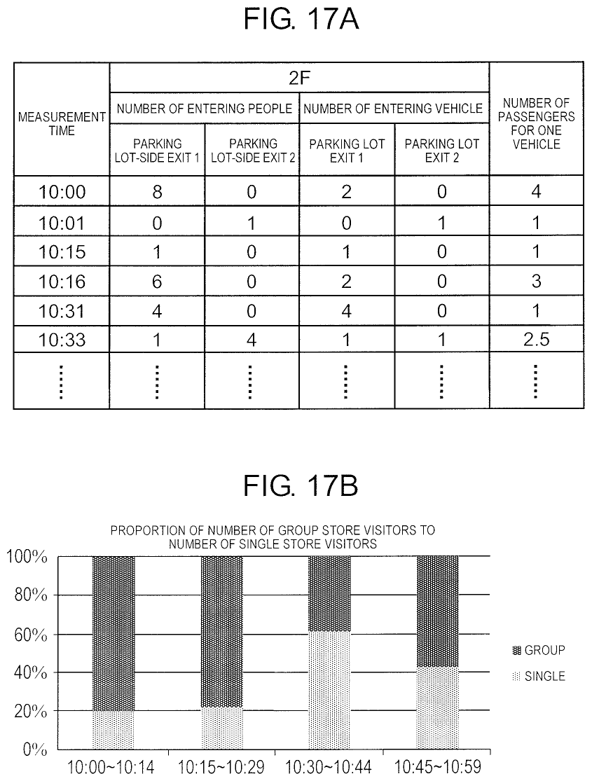

Subsequently, another analysis processing, which is performed in controller 21 of server device 2, will be described. FIG. 17A and FIG. 17B are explanatory diagrams illustrating an example of another analysis processing which is performed in controller 21 of server device 2.

In the parking lot, camera 1, which images an exit of the parking lot on each story, is installed. Camera 1 detects a vehicle which enters the parking lot on each story, and measures the number of vehicles which enter the parking lot on each story on the basis of a result of the detection. In addition, camera 1, which images the parking lot-side exit on the floor of each story, measures the number of people who enter the store on the floor of each story from the parking lot-side exit after getting out from the vehicles in the parking lot.

As described above, in a case where the number of vehicles, which enter the parking lot of each story, and the number of people who enter the store on the floor of each story from the parking lot-side exit are measured, it is possible to acquire the number of passengers for each vehicle, as illustrated in FIG. 17A. It is possible to determine whether the customers visit the store in a group, such as family companions, or a single customer visits the store on the basis of the number of passengers for each vehicle.

Furthermore, when the number of group store visitors, which is the number of customers who visit the store in the group, and the number of single store visitors, which is the number of customers who visit the store alone, are counted for each time zone (for 15 minutes), a graph, which illustrates a proportion of the number of group store visitors for each time zone to the number of single store visitors, is acquired as illustrated in FIG. 17B. With the graph, it is possible for the user to grasp a temporal transition state of the proportion of the number of group store visitors to the number of single store visitors.

Meanwhile, deviation corresponding to necessary time, which is taken for the customers to move from the parking lot to the parking lot-side exit by walk, exists between timing of detecting the vehicles that enter the parking lot and timing of detecting the customers who enter the store from the parking lot-side exit. Therefore, the number of passengers for each vehicle is acquired by taking the necessary time into consideration.

### Second Embodiment

Subsequently, a second embodiment will be described. Meanwhile, cases which are not particularly mentioned here are the same as in the first embodiment.

In the first embodiment, the moving line of the person is acquired and the activity information (the sojourn time and a sojourn frequency) is acquired on the basis of the moving line. However, in the second embodiment, the number of times that each pixel (detection element) of the captured image is located in a person area (area where the person exists) is counted, a moving object activity value (count value) is acquired for each pixel, the moving object activity value is integrated in the target area as the moving object activity value representing the activity level of the person for each pixel through an appropriate statistical processing, for example, averaging, thereby acquiring the activity information of the target area.

First, person detector 42 of camera 1 acquires coordinate information relevant to the person area as the positional information of the person.

Furthermore, activity information generator 44 counts the number of times that each pixel of the captured image is located in the person area on the basis of the coordinate information relevant to the person area acquired in person detector 42, and acquires the moving object activity value (count value) for each pixel as the activity information.

Specifically, whenever each pixel enters the person area, a count value of the pixel increases by 1. Each pixel is continuatively counted in the person area during a predetermined detection unit period, and thus the moving object activity value in units of a pixel for each detection unit period is sequentially acquired. Meanwhile, in a case where continuative entrance to the person area occurs a predetermined number of times (for example, three times), the moving object activity value (count value) may increase by 1 by taking erroneous detection of the person area into consideration.

In this manner, in a case where the moving object activity value for each detection unit period is sequentially acquired, the statistical processing (for example, simply adding and averaging) for integrating the moving object activity value for each detection unit period during the observation period is performed, and the moving object activity value during the observation period is acquired.

Meanwhile, the person area may be a person frame (a rectangular area where the person exists), an upper body area of a detected person, and an existence area of the detected person on the floor.

In server device 2, activity information integrator 54 integrates the activity information, which is acquired in activity information acquirer 52, that is, the moving object activity value for each pixel in the target area, and acquires the moving object activity value for each target area. Particularly, in the embodiment, the moving object activity value for each of the plurality of pixels located in the target area is averaged, and the moving object activity value of the whole target area is acquired.

As described above, the embodiments are described as examples of a technology disclosed in the present application. However, the technology disclosed in the present application is not limited thereto, and may be applied to embodiments on which change, replacement, addition, omission, and the like are performed. In addition, it is possible to combine respective components described in the above embodiments and to make a new embodiment.

For example, in the embodiment, an example of the retail store, such as the department store or the supermarket, is described. However, a target facility is not limited thereto and it is possible to apply the present disclosure to a leisure facility, such as a service area, a resort facility, or a theme park, a commercial facility, such as a shopping mall, or the like. Furthermore, it is possible to apply the present disclosure to a facility other than the commercial facility such as a public facility.

In addition, in the embodiment, an example in which the department is provided in the store floor is described as illustrated in FIG. 7 and FIG. 8. However, in a case where a target facility is not the store, a figure representing a usage area used by the user in the floor, a name of the usage area, and the like are displayed on the planar map image.

In addition, in the embodiment, as illustrated in FIG. 2, the omnidirectional camera, which has a 360-degree photographing range, using the fisheye lens is used as camera 1. However, it is possible to use a camera, which has a predetermined angle of view so-called a box camera.

In addition, in the embodiment, camera 1 performs the respective processes for generating the moving object-removed image, performing the person detection, generating the privacy-protected image, and generating the activity information. However, the entirety or a part of the processes may be performed by server device 2 or a PC which is installed in the store. In addition, in the embodiment, server device 2 performs the respective processes for setting the target area, integrating the activity information, determining the alarm, generating the statistical information, and generating the output information. However, the entirety or a part of the processes may be performed by camera 1 or a PC which is installed in the store.

In addition, in the embodiment, the activity information for each target area is visualized on two facility map images, that is, the sectional map image and the planar map image. However, the two facility map images are not limited to a combination of the sectional map image and the planar map image. For example, a combination of the sectional map image or the planar map image and a map image, acquired by enlarging a part of them, may be used. In addition, it is possible for the user to select the facility map image to be displayed from a plurality of facility map images.

### INDUSTRIAL APPLICABILITY

The intra-facility activity analysis device, the intra-facility activity analysis system, and the intra-facility activity analysis method according to the present disclosure have an advantage in that it is possible for the user to immediately grasp the activity state of the person in an area, which attracts the user's attention, on the inside of the facility, and perform analysis relevant to the activity state of the moving object on the basis of the activity information generated from the captured image acquired by imaging the inside of the facility, thereby being useful as the intra-facility activity analysis device, the intra-facility activity analysis system, and the intra-facility activity analysis method which generate output information in which the activity state of the moving object is visualized.

### REFERENCE MARKS IN THE DRAWINGS

1 CAMERA
2 SERVER DEVICE (INTRA-FACILITY ACTIVITY ANALYSIS DEVICE)
3 USER TERMINAL DEVICE
44 ACTIVITY INFORMATION GENERATOR
51 CAMERA IMAGE ACQUIRER
52 ACTIVITY INFORMATION ACQUIRER
53 TARGET AREA SETTER
54 ACTIVITY INFORMATION INTEGRATOR
56 ALARM DETERMINATOR
57 STATISTICAL INFORMATION GENERATOR
58 OUTPUT INFORMATION GENERATOR
61 DISTRICT LIST MAP IMAGE
62 AREA IMAGE
71 STORE ICON
81 SECTIONAL MAP IMAGE
82 PLANAR MAP IMAGE
83, 84 STATE DISPLAY BOX
141 ALARM ICONS
142 ALARM DISPLAY BOX

1. An intra-facility activity analysis device, which performs analysis relevant to an activity state of a moving object on the basis of activity information generated from a captured image acquired by imaging an inside of a facility, and generates output information acquired by visualizing the activity state of the moving object, the intra-facility activity analysis device comprising:
a processor; and
a memory that stores an instruction,
the device further comprising, as a configuration when the processor executes the instruction stored in the memory;
an activity information acquirer that acquires the activity information representing an activity level of the moving object for each of a plurality of predetermined detection elements acquired through division performed on the captured image;
a target area setter that sets target areas, respectively, on at least two facility map images acquired by drawing a layout on the inside of the facility;
an activity information integrator that generates the activity information for each target area by integrating activity information for each detection element in units of a target area; and
an output information generator that generates display information, which is acquired by visualizing the activity information for each target area, by changing a display shape of an image representing the target area on the facility map images, for each facility map image, and generates the output information which includes the display information relevant to the facility map images.

2. The intra-facility activity analysis device of claim 1
wherein the facility map images includes a sectional map image acquired by drawing a sectional layout of a building included in the facility, and a planar map image acquired by drawing a planar layout on a floor on the inside of the building.

3. The intra-facility activity analysis device of claim 2,
wherein the output information generator generates the display information used to display the planar map image relevant to a designated floor according to an input operation for designating the floor on the sectional map image by the user.

4. The intra-facility activity analysis device of claim 1, further comprising:
an alarm determinator that determines whether or not an alarm for disaster prevention is necessary for each target area on the basis of the number of current staying people, which is acquired in the activity information acquirer, for each target area,
wherein the output information generator generates the display information acquired by superimposing an alarm icon on a location corresponding to the target area, in which it is determined that the alarm for the disaster prevention is necessary, on the facility map image on the basis of a result of determination performed by the alarm determinator.

5. The intra-facility activity analysis device of claim 1,
wherein the activity information integrator integrates the activity information for each detection element in units of a facility, generates the activity information for each facility, averages the activity information for each facility in units of a district, and generates activity information for each district, and
wherein the output information generator generates the display information, which is acquired by visualizing the activity information for each district, by changing a display shape of an image representing the district on a district list map image.

6. An intra-facility activity analysis system, which performs analysis relevant to an activity state of a moving object on the basis of activity information generated from a captured image acquired by imaging an inside of a facility, and generates output information acquired by visualizing the activity state of the moving object, the intra-facility activity analysis system comprising:
a camera that images the inside of the facility, generates the activity information representing an activity level of the moving object for each of a plurality of predetermined detection elements acquired through division performed on the captured image, and outputs the activity information;
a server device that generates the output information acquired by visualizing the activity information; and
a user terminal device that displays a reading screen acquired by visualizing the activity information on the basis of the output information,
wherein the server device includes
an activity information acquirer that acquires the activity information from the camera;
a target area setter that sets target areas, respectively, on at least two facility map images acquired by drawing a layout on the inside of the facility;
an activity information integrator that generates the activity information for each target area by integrating activity information for each detection element in units of a target area; and
an output information generator that generates display information, which is acquired by visualizing the activity information for each target area, by changing a display shape of an image representing the target area on the facility map images, for each facility map image, and generates the output information which includes the display information relevant to the facility map images.

7. An intra-facility activity analysis method causing an information processing device to perform analysis relevant to an activity state of a moving object on the basis of activity information generated from a captured image acquired by imaging an inside of a facility and to generate output information acquired by visualizing the activity state of the moving object, the intra-facility activity analysis method comprising:
acquiring the activity information representing an activity level of the moving object for each of a plurality of predetermined detection elements acquired through division performed on the captured image;
setting target areas, respectively, on at least two facility map images acquired by drawing a layout on the inside of the facility;
generating the activity information for each target area by integrating activity information for each detection element in units of a target area; and
generating display information, which is acquired by visualizing the activity information for each target area, by changing a display shape of an image representing the target area on the facility map images, for each facility map image, and generating the output information which includes the display information relevant to the facility map images.
